(19) United States
(12) Patent Application Publication
(10) Pub. No.: US 2019/0195078 A1
(43) Pub. Date: Jun. 27, 2019

(54) CONTACTING FACE SEAL

(71) Applicant: PRATT & WHITNEY CANADA CORP., Longueuil (CA)

(72) Inventor: Dany BLAIS, Sainte-Julie (CA)

(21) Appl. No.: 15/850,804

(22) Filed: Dec. 21, 2017

(51) Int. Cl. F01D 11/00; F16J 15/34

(52) U.S. Cl. CPC F01D 11/003; F16J 15/3444; F05D 2220/32; F05D 2240/55; F16J 15/3452

(57) ABSTRACT

A contacting face seal component comprises a circumferential body defined as an annulus extending between an outer periphery and an inner periphery around a center axis, the circumferential body including a contact surface configured for face-sealing engagement with a relatively rotating member, an annular groove defined in the contact surface about the center axis, the annular groove defining in the contact face a sealing lip and at least one load distribution pad radially spaced from one another by the annular groove; and at least one passage extending between the annular groove and the outer periphery to fluidly connect with an outer side of the circumferential body.

### TECHNICAL FIELD

The application relates generally to face seals and, more particularly, to contacting face seals for a gas turbine engine.

### BACKGROUND OF THE ART

In a contacting face seal, the resultant axial force acting on the face seal is generally a combination of a pressure gradient across a sealing contact surface of the face seal and an axial force from a spring or magnet acting on the face seal. Therefore, the resultant axial force can vary significantly with the pressure gradient acting on the face seal across the contact surface. Consequently, the pressure gradient across the contact surface may affect the durability of the face seal and may deteriorate the tightness of the seal.

### SUMMARY

In one aspect, there is provided a contacting face seal component comprising a circumferential body defined as an annulus extending between an outer periphery and an inner periphery around a center axis, the circumferential body including a contact surface configured for face-sealing engagement with a relatively rotating member, an annular groove defined in the contact surface about the center axis, the annular groove defining in the contact face a sealing lip and at least one load distribution pad radially spaced from one another by the annular groove; and at least one passage extending between the annular groove and the outer periphery to fluidly connect with an outside of the circumferential body.

In another aspect, there is provided a sealing assembly for a gas turbine engine, the sealing assembly comprising a first fluidic environment adapted to have a first pressure; a second fluidic environment adapted to have a second pressure lower than the first pressure; a relatively rotating member disposed between the first and second fluidic environments; and a circumferential sealing element disposed between the first and second fluidic environments opposite of the relatively rotating member, the sealing element comprising a circumferential body defined as an annulus extending between an outer periphery and an inner periphery around a center axis, the circumferential body including a contact surface configured for face-sealing engagement with the relatively rotating member, an annular groove defined in the contact surface about the center axis, the annular groove defining in the contact face a sealing lip and at least one load distribution pad radially spaced from one another by the annular groove, at least one passage extending between the annular groove and the first fluidic environment to fluidly connect the annular groove with the first fluidic environment; and a bias member biasing the contact surface and the relatively rotating member toward each other.

In a further aspect, there is provided a method for sealing a space between a first fluidic environment and a second fluidic environment of a gas turbine engine, the first fluidic environment having a first pressure and the second fluidic environment having a second pressure, the first pressure being higher than the second pressure, the method comprising sealingly engaging a contact surface of a circumferential body of a contacting face seal with a relatively rotating member in the space between the first fluidic environment and the second fluidic environment; directing a flow of the first fluidic environment into an annular groove defined in the contact surface between a radially inner annular sealing lip of the circumferential body and at least one radially outer load distribution pad of the circumferential body such that the at least one load distribution pad is entirely surrounded by the first fluidic environment; balancing a closing hydraulic pressure with an opening hydraulic pressure across the at least one load distribution pad resulting from surrounding the at least one load distribution pad with the first fluidic environment; and biasing the contacting face seal and the relatively rotating member toward each other.

In a further aspect, there is provided a contacting face seal component comprising a circumferential body of contact material defined as an annulus extending between an outer periphery and an inner periphery around a center axis, the circumferential body of contact material, the contact material defining a contact surface configured for face-sealing engagement with a relatively rotating member, an annular groove defined directly in the contact material and in the contact surface about the center axis, the annular groove defining in the contact face a sealing lip and at least one load distribution pad radially spaced from one another by the annular groove; and at least one passage defined in the circumferential body and extending between the outer periphery and the groove such that the groove is fluidly connected with an outside of the circumferential body.

### DESCRIPTION OF THE DRAWINGS

Reference is now made to the accompanying figures in which:

FIG. 1 is a schematic cross-sectional view of a gas turbine engine;

FIG. 2 is a schematic cross-sectional view of a sealing assembly in accordance to a particular embodiment;

FIG. 3 is a cross-sectional view of a contacting face seal in accordance to another particular embodiment;

FIG. 4 is a transverse cross-sectional view of a sealing assembly including the contacting face seal taken along line 4-4 of FIG. 3;

FIG. 5A is a schematic view illustrating axial pressures acting on the face seal of FIG. 4;

FIG. 5B is a schematic view illustrating non-balanced axial pressures acting on the face seal of FIG. 5; and

FIG. 6 is a cross-sectional view of the sealing assembly of FIG. 4 in accordance to another particular embodiment.

### DETAILED DESCRIPTION

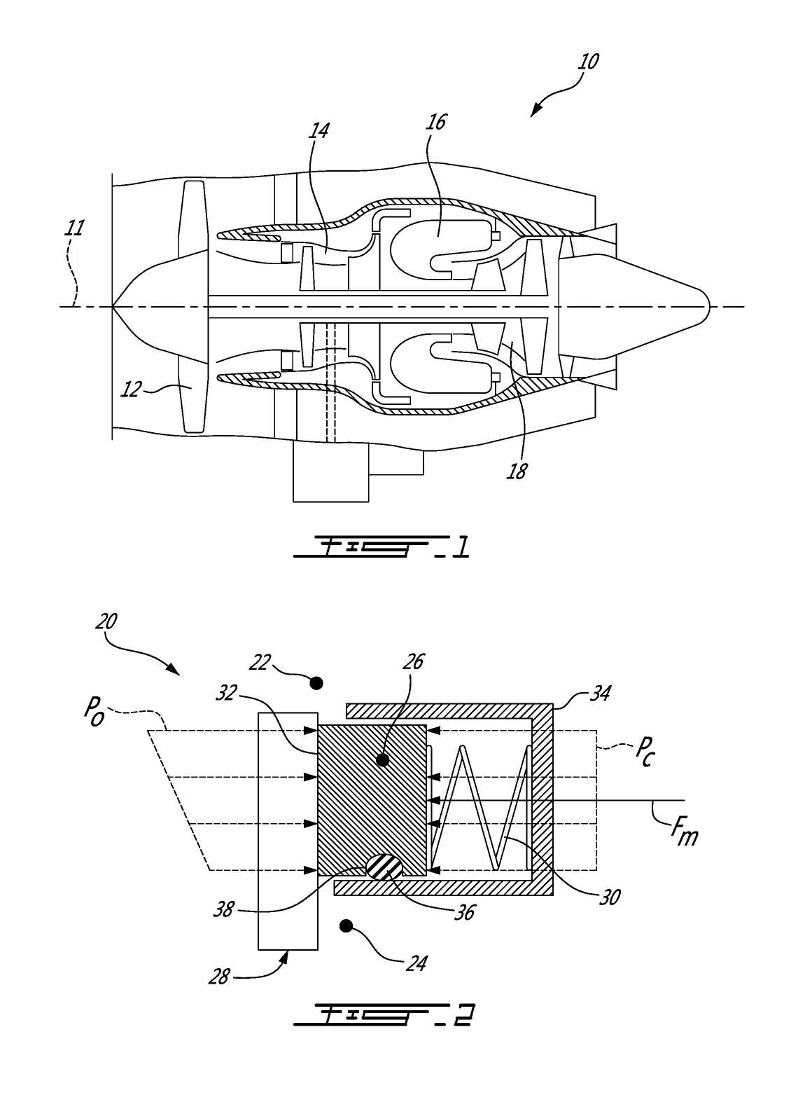

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases.

FIG. 2 illustrates a sealing assembly 20 in accordance to a particular embodiment. The sealing assembly 20 can be used in the gas turbine engine 10 to seal a space between a high pressure environment 22 and a low pressure environment 24. The high pressure environment 22 can be a first fluidic environment of the gas turbine engine that contains pressurized air and the low pressure environment 24 can be a second fluidic environment of the gas turbine engine 10 that contains air at a lower pressure than a pressure of the pressurized air of the first fluidic environment. The air in the second fluidic environment can also be pressurized, however, at a lower pressure than the “pressurized” air of the first fluidic environment. The pressure difference between the high and low pressure environments 22, 24 is referred to herein as a pressure differential.

The sealing assembly 20 includes a contacting face seal 26, a relatively rotating member 28 and a bias member 30 to bias the face seal 26 and the relatively rotating member 28 toward each other. The relatively rotating member 28 is a member that rotates relative to the face seal 26. By “relatively rotating”, it is understood that in operation at least one of the face seal 26 and the member 28 rotates. The relatively rotating member 28 can be known as a seal runner when it rotates.

The face seal 26 is disposed within the space between the high and low pressure environments 22, 24 opposite the relatively rotating member 28. The bias member 30 of the sealing assembly 20 is shown as a spring. The spring applies a force to bias the face seal 26 toward the seal runner 30 to sealingly engage a contact surface 32 of the face seal 26 with the relatively rotating member 28. In the embodiment shown in FIG. 2, a housing 34 of the sealing assembly 20 receives the spring and a portion of the face seal 26. An O-ring 36, or any appropriate type of seal or seals, is received in a slot 38 of the face seal 26 between the face seal 26 and the housing 34, to prevent or to reduce air leakage therebetween. The contact between the face seal 26 and the housing 34 may be generally airtight, whereby no additional seal may be required.

The spring applies a mechanical axial force Fm on the face seal 26 in a direction X1. Moreover, the face seal 26 can be affected by hydraulic forces due to the pressure differential. The hydraulic forces include an axial closing force as a resultant of closing pressure Pc and an opposite axial opening force as a resultant of opening pressure Po. The total net forces acting axially on the face seal 26 can be expressed as the sum of the mechanical force Fm and the hydraulic opening and closing forces. The pressure differential causes a pressure gradient of the opening pressure Po. The term “pressure gradient” is intended to indicate that an opening pressure (i.e. force per unit area) acting axially on the contact surface 32 toward the high pressure environment 22 is larger than a pressure acting axially on the contact surface 32 toward the low pressure environment 24. Thus, the net axial hydraulic force acting on the face seal 26 can vary radially along the contact surface 32 and consequently the net force (mechanical force Fm and hydraulic forces) acting on the face seal 26 varies radially along the contact surface 32. Hence, frictional forces resulting from the pressure gradient on the face seal 26 during relative rotation between the face seal 26 and the relatively rotating member 28 may be proportional to the net forces. In operation, as the pressure differential increases between the high and low pressure environments 22, 24, the hydraulic opening force applied across the contact surface 32 can develop the pressure gradient. In a particular embodiment, as the pressure differential increases, the pressure gradient consequently increases.

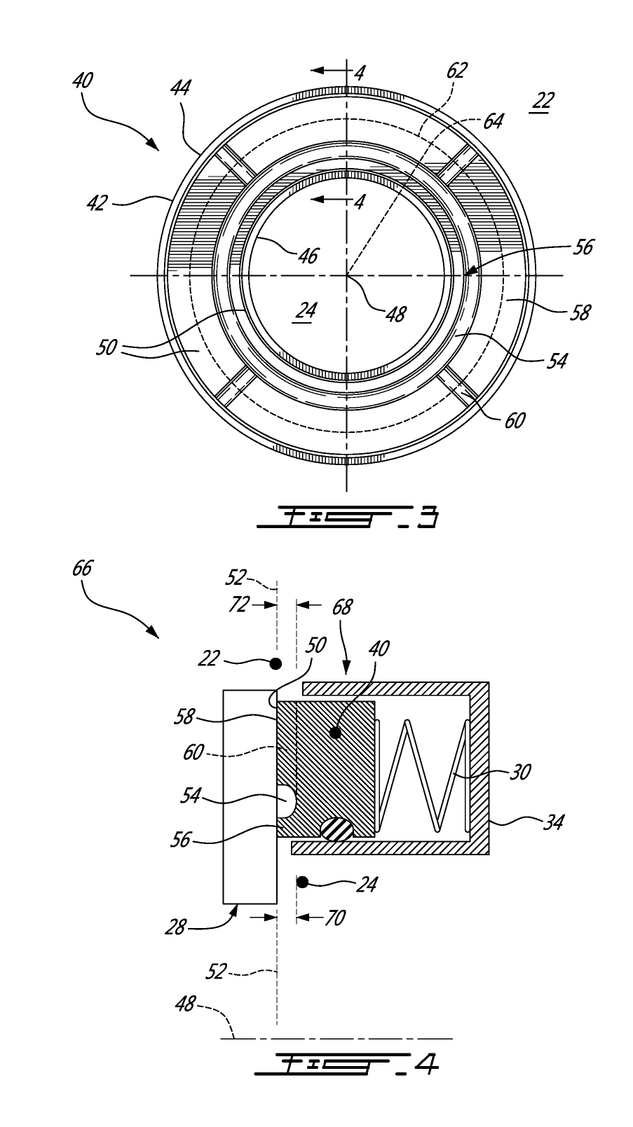

Referring to FIG. 3, a face seal 40 is shown in accordance to another particular embodiment. The face seal 40 includes a body 42 defined as an annulus between an outer periphery 44 and an inner periphery 46 around a center axis 48 of the face seal 40. The body 42 may be referred to as a surrounding body as it surrounds a shaft, an annular body as it may have an annular shape as in FIG. 3, or a circumferential body as it circumscribes around a shaft. The outer periphery 44 is radially outward from the inner periphery 46 relative to the center axis 48. The body 42 has two or more spaced-apart opposite surfaces extending between the outer and inner peripheries 44, 46. One of the two opposite surfaces is a contact surface 50 that extends in a single plane 52 and configured for sealing engagement with the relatively rotating member 28. The contact surface 50 can be made from the same material and/or be coated with any suitable material. According to an embodiment, the contact surface 50 is formed by contact material of the body 42. The contact material may be any appropriate material configured to seal while rotating relative to another component, such as the relatively rotating member 28. In an embodiment, the contact material is a monolithic or monoblock component, with subcomponents defined by grooves therein, as described below. Stated differently, the contact material may be an annular plate or disc of a single make, with static subcomponents therein resulting from grooves, such as a sealing lip, load distribution pad(s), etc. Such subcomponents of the contact material are static relative to one another, as they are integral to the body 42. In an embodiment, the contact surface 50 is flat, and is part of a single plane. In another embodiment, the contact surface 50 is frustoconical.

The face seal 40 includes a groove 54 defined in the contact surface 50 such that the groove 54 separates and defines “protruding portions” of the contact surface 50. The term “protruding portion” refers to the portion of the contact surface 50 that appears to extend from the face seal 40 because of the groove 54 or concave depression formed in the contact surface 50. The term “protruding portion” is not intended to indicate a portion that extends beyond the plane 52 of the contact surface 50. The groove 54 can be machined, molded or cast in the contact surface 50 (or provided by any suitable method) to define the portions. These portions are referred to as a sealing lip 56 “portion” and a load distribution pad or pads 58 “portion”.

In the particular embodiment shown in FIG. 3, the sealing lip 56 may be a continuous annular sealing lip 56 disposed radially inward from the load distribution pads 58 relative to the center axis 48. The groove 54 circumferentially surrounds the entire sealing lip 56. In an alternate embodiment, the sealing lip 56 can have a different shape or form, such as square, non-circular, etc. The sealing lip 56 may extend radially between the inner periphery 46 and the groove 54. The sealing lip 56 may have several functions. One of these functions is to provide air tightness of the contact surface 50 with the relatively rotating member 28.

The face seal 40 may also include one or more access grooves 60 defined in the body 42 and extending between the outer periphery 44 and the groove 54. The access groove(s) 60 acts as a channel to fluidly connects the groove 54 with high pressure environment 22, for a pressure of the groove 54 to be at or close to the pressure of the high pressure environment 22. In the embodiment shown in FIG. 3, the access grooves 60 are defined in the contact surface 50 across the load distribution pad 58. The access groove 60 separates the load distribution pad 58 into pad segments, pads, or “protruding portions” at the contact surface 50. The access groove 60 can be formed in the contact surface 50 by any suitable method (e.g., machined, molded, cast). In the embodiment shown in FIG. 3, the access groove 60 extends radially in a straight line relative to the center axis 48 between the outer periphery 44 and the groove 54. In an alternate embodiment, the access groove 60 can be curved and/or extend at angle relative to a radial straight line. However, a radially straight line of the access groove 60 can maximize a surface contact area of the load distribution pad 58. In an alternate embodiment, the access groove 60 can be a passage formed by a drilling process, or the like, through the load distribution pad 58. As a result, the passage is circumscribed by the pad 58. The passage can be circular or any other suitable shape.

Referring to FIG. 3, the face seal 40 includes four access grooves 60 that are equally spaced circumferentially and define four uniformly shaped load distribution pads 58. Equally spacing the access grooves 60 can evenly distribute pressure loads on the load distribution pads 58. In an alternate embodiment, the face seal 40 includes any suitable number of access grooves 60 or passages. The contact surface 50 is thus formed from the sealing lip 56 in conjunction with the one or more load distribution pads 58 in the single plane 52. That is, no other parts of the face seal 40 form part of the contact surface 50 or engage the relatively rotating member 28 for sealing purposes. In a particular embodiment, the sealing lip 56 and the load distribution pads 58 do not move or rotate relative to the plane 52. They are integrally formed together to form the face seal 40 as described above.

In another particular embodiment, the load distribution pad or pads 58 extend along, or cover, at least 50% of an entire span 62 of the plane 52 at a radial position 64. The span 62 in this example represents an imaginary diameter that passes through the radial position 64. The radial position 64 can be chosen along a radii between the center axis 48 and the outer periphery 44, radially outwardly from the groove 54. Stated differently, the span 62 in the plane 52 is at least 50% covered by the load distribution pads 58. In another embodiment, the load distribution pads 58 make up at least 50% of the footprint of the face seal 40 from the axial point of view of FIG. 3. The area or areas not covered by the load distribution pads 58 may be covered by the access grooves 60. In another embodiment, the load distribution pad or pads 58 extend along at least 75% of the entire span 62 at the radial position 64. Although in the embodiments shown the sealing lip 56 is described and shown to be inwardly from the load distribution pads 58, in other embodiments, the sealing lip 56 can be disposed radially outwardly from the load distribution pads 58 and the first fluidic environment can be the low pressure environment 24 and the second fluidic environment can be the high pressure environment 22.

FIG. 4 illustrates a transvers cross-sectional view of the face seal 40 taken along line 4-4 of FIG. 3, and shown as part of a sealing assembly 66. The sealing assembly 66 is disposed between the high and low pressure environments 22, 24 to seal the space therebetween. A sealing element 68 is shown in a sealing engagement with the relatively rotating member 28. The sealing element 68 includes the housing 34, the bias member 30 and the face seal 40. In the embodiment shown, the center axis 48 is normal to the plane 52 of the contact surface 50. In an alternate embodiment, the center axis 48 can be in an angled, non-normal, relation with the contact surface 50. The bias member 30 is received in the housing 34 and the face seal 40 is mounted between the housing 34 and the relatively rotating member 28. The bias member 30 biases the face seal 40 toward the relatively rotating member 28 such that the contact surface 50 sealingly engage the member 28. In an alternate embodiment, the bias member 30 can be replaced with any suitable biasing device. For example, a magnetic seal arrangement can be used for magnetic forces to bring the face seal 40 into contacting engagement with the relatively rotating member 28.

A depth 70 of the access grooves 60 is equal to a depth 72 of the groove 54 relative to the contact surface 50. In an alternate embodiment, the depth 70 of the access groove(s) can be different from the depth 72 of the groove 54.

In operation, pressurized air flows from the high pressure environment 22 into the groove 54 though the passage or access grooves 60. As such, the one or more load distribution pads 58 are surrounded by pressurized air of the high pressure environment 22 and thus there is no pressure differential across the pads 58. In other words, the pads 58 are surrounded by the same pressure.

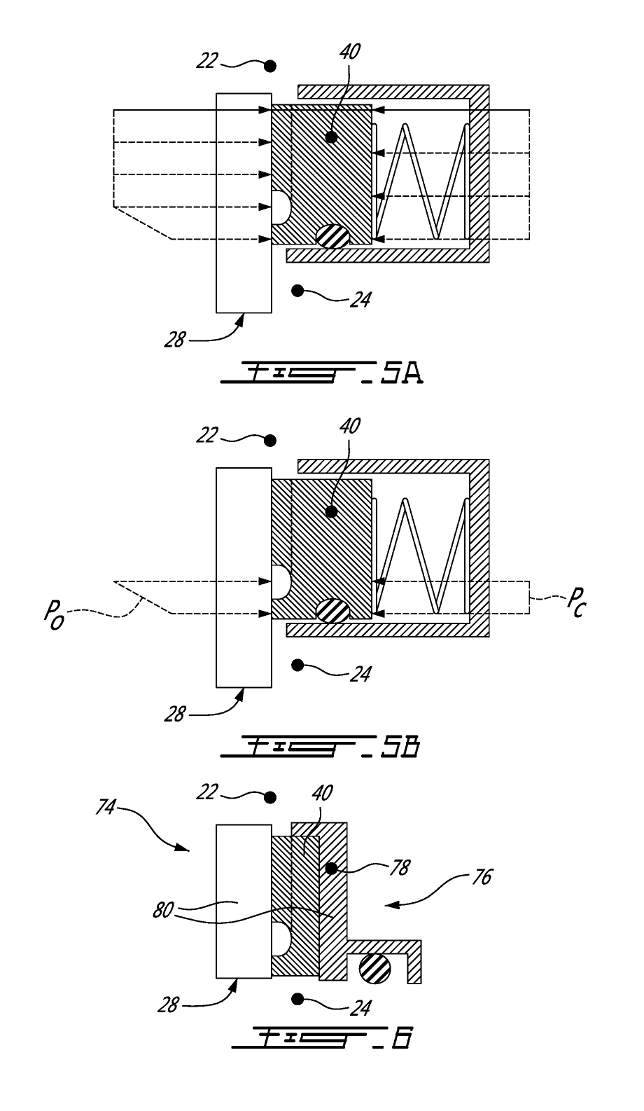

FIG. 5A illustrates the opening pressure acting on the face seal 40. The opening pressure across the load distribution pads 58 becomes constant across the load distribution pads 58 since there is no pressure differential across the pads 58. The pressure gradient is eliminated or reduced because there is no longer a pressure differential across the pads 58. The sealing lip 56 experiences a pressure gradient because there is a pressure differential across the sealing lip 56. The contacting area of the sealing lip 56 is smaller than the contacting area of the pads 58. Accordingly, the pressure gradient impacts the frictional losses for a smaller portion of the face seal 40, as the pressure gradient is present on a smaller surface of the face seal 40, i.e., that defined by the sealing lip 56. In a particular embodiment, the contacting area of the sealing lip 56 is at most 25% of the contacting area of the pads 58. The term “contacting area” is intended to indicate an area of the contact surface 50 that sealingly engage the relatively rotating member 28.

FIG. 5B illustrates the pressure gradient across the sealing lip 56. The hydraulic pressures across the pads 58 are not shown. The closing hydraulic pressure Pc is balanced by the opening hydraulic pressure Po over the load distribution pads 58. That is, the net axial hydraulic pressure across the pads 58 is zero.

Referring to FIG. 6, a sealing assembly 74 is shown in accordance to another particular embodiment. In this embodiment, the same or similar structural elements as to the elements of the previous embodiments are designated by the same reference numerals. The relatively rotating member 28 includes a magnet. For example, the relatively rotating member 28 can be a static magnet and the face seal 40 rotates during the operation of the sealing assembly 74. The term “magnet” is intended to include, in at least one embodiment, a body that produces a magnetic field externally unto itself. In an alternate embodiment, the relatively rotating member 28 includes internal magnets, surface mounted magnets and the like. A sealing element 76 is shown which includes a seat 78 receiving the face seal 40. The seat 78 includes a ferrous material such that the magnet and the seat 78 are magnetically attracted. The term “ferrous” or “ferrous material” can indicate any material to which the magnet is attracted thus creating an adherent force or magnetic attraction. The ferrous material can include for example any metal or alloy that is primarily made up of iron or steel. In this particular embodiment, the magnet and the seat 78 form a biasing member 80. Other biasing members can also be used, such as the spring.

In operation, according to a particular embodiment, sealing the space between the high and low pressure environments 22, 24 includes sealingly engaging the contact surface 50 of the face seal 40 with the relatively rotating member 28, biasing the face seal 40 toward the relatively rotating member 28 and directing a flow of the high pressure environment 22 into the groove 54 through the access groove 60 or passage.

The above description is meant to be exemplary only, and one skilled in the art will recognize that changes may be made to the embodiments described without departing from the scope of the invention disclosed. For example, the pressurized air can be substituted for other fluids. Still other modifications which fall within the scope of the present invention will be apparent to those skilled in the art, in light of a review of this disclosure, and such modifications are intended to fall within the appended claims.

1. A contacting face seal component comprising:
a circumferential body defined as an annulus extending between an outer periphery and an inner periphery around a center axis, the circumferential body including a contact surface configured for face-sealing engagement with a relatively rotating member, an annular groove defined in the contact surface about the center axis, the annular groove defining in the contact face a sealing lip and at least one load distribution pad radially spaced from one another by the annular groove; and
at least one passage extending between the annular groove and the outer periphery to fluidly connect with an outside of the circumferential body.

2. The contacting face seal as defined in claim 1, wherein the at least one passage is defined in the circumferential body away from the contact surface.

3. The contacting face seal as defined in claim 1, wherein the at least one load distribution pad extends along at least 50% of an entire span of the contact surface at a radial position.

4. The contacting face seal as defined in claim 1, wherein the contact surface extends in a plane normal to the center axis.

5. The contacting face seal as defined in claim 1, wherein the at least one passage is an access groove defined in the contact surface across the at least one load distribution pad.

6. The contacting face seal as defined in claim 5, wherein the access groove extends generally radially relative to the center axis.

7. The contacting face seal as defined in claim 5, wherein the access groove and the annular groove have equal depth.

8. The contacting face seal as defined in claim 1, wherein the at least one passage includes at least two equally spaced access grooves defined in the contact surface and radially extend relative to the center axis.

9. A sealing assembly for a gas turbine engine, the sealing assembly comprising:
a first fluidic environment adapted to have a first pressure;
a second fluidic environment adapted to have a second pressure lower than the first pressure;
a relatively rotating member disposed between the first and second fluidic environments; and
a circumferential sealing element disposed between the first and second fluidic environments opposite of the relatively rotating member, the sealing element comprising:
a circumferential body defined as an annulus extending between an outer periphery and an inner periphery around a center axis, the circumferential body including a contact surface configured for face-sealing engagement with the relatively rotating member, an annular groove defined in the contact surface about the center axis, the annular groove defining in the contact face a sealing lip and at least one load distribution pad radially spaced from one another by the annular groove, at least one passage extending between the annular groove and the first fluidic environment to fluidly connect the annular groove with the first fluidic environment; and
a bias member biasing the contact surface and the relatively rotating member toward each other.

10. The sealing assembly as defined in claim 9, wherein the contact surface is perpendicular to the center axis and the at least one load distribution pad extends along at least 50% of an entire span of the contact surface at a radial position.

11. The sealing assembly as defined in claim 9, wherein the at least one passage is an access groove defined in the contact surface across the at least one load distribution pad.

12. The sealing assembly as defined in claim 11, wherein the access groove extends generally radially relative to the center axis.

13. The sealing assembly as defined in claim 11, wherein the access groove and the annular groove have equal depth.

14. The sealing assembly as defined in claim 9, wherein the at least one passage includes at least two equally spaced access grooves defined in the contact surface and radially extend relative to the center axis.

15. The sealing assembly as defined in claim 9, wherein the relatively rotating member includes a magnet and the sealing element includes a seat receiving the circumferential body, the seat including a ferrous material such that the magnet and the seat are magnetically attracted, the bias member comprises the magnet and the seat.

16. The sealing assembly as defined in claim 9, wherein the bias member includes a spring urging the circumferential body toward the relatively rotating member.

17. A method for sealing a space between a first fluidic environment and a second fluidic environment of a gas turbine engine, the first fluidic environment having a first pressure and the second fluidic environment having a second pressure, the first pressure being higher than the second pressure, the method comprising:
sealingly engaging a contact surface of a circumferential body of a contacting face seal with a relatively rotating member in the space between the first fluidic environment and the second fluidic environment;
directing a flow of the first fluidic environment into an annular groove defined in the contact surface between a radially inner annular sealing lip of the circumferential body and at least one radially outer load distribution pad of the circumferential body such that the at least one load distribution pad is entirely surrounded by the first fluidic environment;
balancing a closing hydraulic pressure with an opening hydraulic pressure across the at least one load distribution pad resulting from surrounding the at least one load distribution pad with the first fluidic environment; and
biasing the contacting face seal and the relatively rotating member toward each other.

18. The method as defined in claim 17, wherein the flow of the first fluidic environment is directed radially relative to a center axis of the contacting face seal.

19. The method as defined in claim 17, comprising rotating one of the contacting face seal and the relatively rotating member.

20. The method as defined in claim 17, comprising at least one radially extending access groove defined in the contact surface across the at least one load distribution pad and directing the flow of the first fluidic environment through the at least one access groove.
